(19) United States
(12) Patent Application Publication
(10) Pub. No.: US 2026/0311513 A1
(43) Pub. Date: Oct. 8, 2026

(54) INFORMATION ANALYSIS SYSTEM, INFORMATION ANALYSIS METHOD, AND NON-TRANSITORY COMPUTER-READABLE RECORDING MEDIUM

(71) Applicant: KONICA MINOLTA, INC., Chiyoda-ku, Tokyo (JP)

(72) Inventors: Kazuki TSUTSUKAWA, Osaka (JP); Taiki SEKII, Osaka (JP)

(73) Assignee: KONICA MINOLTA, INC., Chiyoda-ku, Tokyo (JP)

(21) Appl. No.: 19/481,774

(22) PCT Filed: May 8, 2023
(86) PCT No.: PCT/JP2023/017332

§ 371 Date: Nov. 5, 2025

(51) Int. Cl. G06V 40/20; G06F 40/40; G06V 10/70; G06V 20/40

(52) U.S. Cl. CPC G06V 40/20; G06F 40/40; G06V 10/70; G06V 20/49

(57) ABSTRACT

Disclosed is a technique for realizing information analysis based on analysis contents flexibly designated for moving image data. One aspect of the present disclosure relates to an information analysis system comprising: an acquisition unit that acquires non-language time-series data; a recognition unit that recognizes a target situation on the basis of the non-language time-series data; a storage unit that stores the target situation as language data log information; a reception unit that receives an analysis request; an analysis unit that executes analysis on the basis of the log information and the analysis request; and an output unit that outputs the results of the analysis.

### TECHNICAL FIELD

The present disclosure relates to an information analysis system, an information analysis method, and a program.

### BACKGROUND ART

With the recent development of deep learning technologies, opportunities to utilize machine learning model have expanded. For example, a behavior recognition model trained to recognize a behavior of a person from a moving image including an object such as a person or a thing has been utilized, which makes it possible to recognize what a person imaged by a video camera is doing.

### CITATION LIST

### Non-Patent Literatures (Hereinafter, Non Patent Literature Will be Referred to as “NPL”)

### NPL 1

“Language Models are Few-Shot Learners”, arXiv: 2005.14165v4, Jul. 22, 2020.

### NPL 2

“Towards General Purpose Vision Systems: An End-to-End Task-Agnostic Vision-Language Architecture”, Proceedings-2022 IEEE/CVF Conference on Computer Vision and Pattern Recognition, CVPR 2022.

### SUMMARY OF INVENTION

### Technical Problem

However, it is difficult to perform behavior analysis by inputting moving image data for a long time into a machine learning model, and what a conventional behavior recognition model can perform is confined to behavior analysis only for a specific task specified at the time of model training.

In consideration of the above-described problems, one object of the present disclosure is to provide a technology for realizing information analysis based on an analysis content flexibly specified for moving image data.

### Solution to Problem

An aspect of the present disclosure relates to an information analysis system including:
an acquirer that acquires non-language time-series data;
a recognizer that recognizes a situation of a target based on the non-language time-series data;
a storage that stores the situation of the target as log information of language data;
a receiver that receives an analysis request;
an analyzer that executes analysis based on the log information and the analysis request; and
an outputter that outputs a result of the analysis.

### Advantageous Effects of Invention

According to the present disclosure, it is possible to provide a technique for realizing information analysis based on an analysis content flexibly specified for moving image data.

### BRIEF DESCRIPTION OF THE DRAWINGS

FIG. 1 is a schematic diagram illustrating information analysis processing according to an exemplary embodiment of the present disclosure;

FIG. 2 is a schematic diagram illustrating an information analysis apparatus according to an exemplary embodiment of the present disclosure;

FIG. 3 is a block diagram illustrating a hardware configuration of the information analysis apparatus according to an exemplary embodiment of the present disclosure;

FIG. 4 is a block diagram illustrating a functional configuration of the information analysis apparatus according to an exemplary embodiment of the present disclosure;

FIG. 5 is a diagram provided for describing behavior recognition processing according to an exemplary embodiment of the present disclosure;

FIG. 6 is a diagram provided for describing training processing of a behavior recognition model according to an exemplary embodiment of the present disclosure;

FIG. 7 is a diagram provided for describing inference processing of the behavior recognition model according to an exemplary embodiment of the present disclosure;

FIG. 8 is a diagram illustrating an example of a screen for specifying an analysis content according to an exemplary embodiment of the present disclosure; and

FIG. 9 is a flowchart illustrating information analysis processing according to an exemplary embodiment of the present disclosure.

### DESCRIPTION OF EMBODIMENTS

Hereinafter, an embodiment of the present disclosure will be described with reference to the accompanying drawings.

In the following exemplary embodiment, an information analysis system that generates an analysis result related to a target in non-language time-series data such as moving image data is disclosed.

### Outline of the Present Disclosure

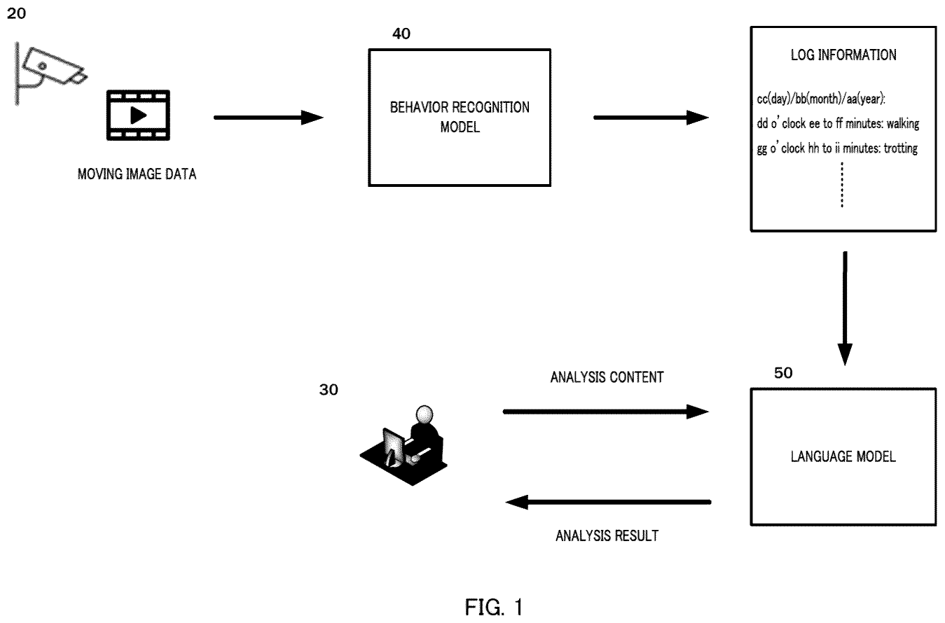

As illustrated in FIG. 1, in information analysis processing according to an exemplary embodiment of the present disclosure, log information indicating a recognition result of a behavior of an imaged target person and/or an operation of an imaged target thing is acquired from moving image data imaged by an imaging apparatus 20 or the like, such as a camera, by utilizing a behavior recognition model 40. For example, the log information may be a time-series recognition result of a behavior of a target person and/or an operation of a target thing. Then, an analysis content provided from a user terminal 30 and the log information are input into a language model 50 such as ChatGPT, and a result of analysis performed on the log information according to the analysis content is returned to the user terminal 30. For example, the analysis content may read: “What is the total time during which the target person has started walking and then has trotted on cc(day)/bb(month)/aa(year)?” or the like. In this case, the language model 50 may total the time during which the target person has “walked” and then has “trotted”, which has been determined by the behavior recognition model 40 in the log information on cc(day)/bb(month)/aa(year), and may return an analysis result that reads: “The total time during which the target person has started walking and then has trotted is xx minutes.” or the like to the user terminal 30.

Although a typical behavior recognition model makes it possible to recognize each operation such as “walking” and “trotting”, it is difficult to set a composite operation of “has started walking and then has trotted” as an analysis content. The information analysis processing of the illustrated exemplary embodiment makes it possible to set such a composite operation as an analysis content.

### Information Analysis System

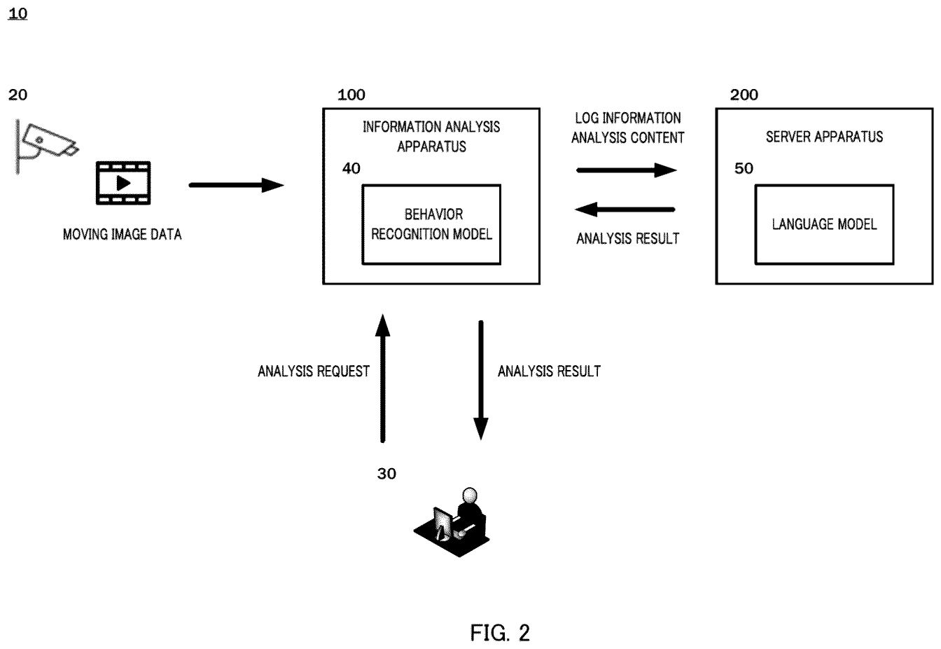

FIG. 2 is a schematic diagram illustrating an information analysis system according to an exemplary embodiment of the present disclosure. As illustrated in FIG. 2, an information analysis system 10 includes the imaging apparatus 20, the user terminal 30, an information analysis apparatus 100, and a server apparatus 200.

The imaging apparatus 20 is, for example, a video camera or the like, and images a region to be imaged and generates moving image data. The moving image data is transmitted to the information analysis apparatus 100.

The user terminal 30 may be realized by any information processing apparatus such as a personal computer (PC), a tablet, or a smartphone, for example. The user terminal 30 transmits an analysis request including an analysis content for moving image data to the information analysis apparatus 100, and acquires an analysis result for the analysis content from the information analysis apparatus 100.

The information analysis apparatus 100 executes analysis based on the analysis content received from the user terminal 30 on the moving image data received from the imaging apparatus 20 and returns the analysis result to the user terminal 30. The information analysis apparatus 100 according to the following exemplary embodiment executes analysis by utilizing the behavior recognition model 40 and the language model 50, as will be described in detail later.

When the server apparatus 200 acquires the log information and the analysis content from the information analysis apparatus 100, the server apparatus 200 executes the language model 50 and returns an analysis result based on the analysis content for the log information to the information analysis apparatus 100.

Note that, in the illustrated exemplary embodiment, the behavior recognition model 40 is stored in the information analysis apparatus 100 and the language model 50 is stored in the server apparatus 200, but the behavior recognition model 40 and the language model 50 according to the present disclosure are not limited thereto and any other configuration may also be applied.

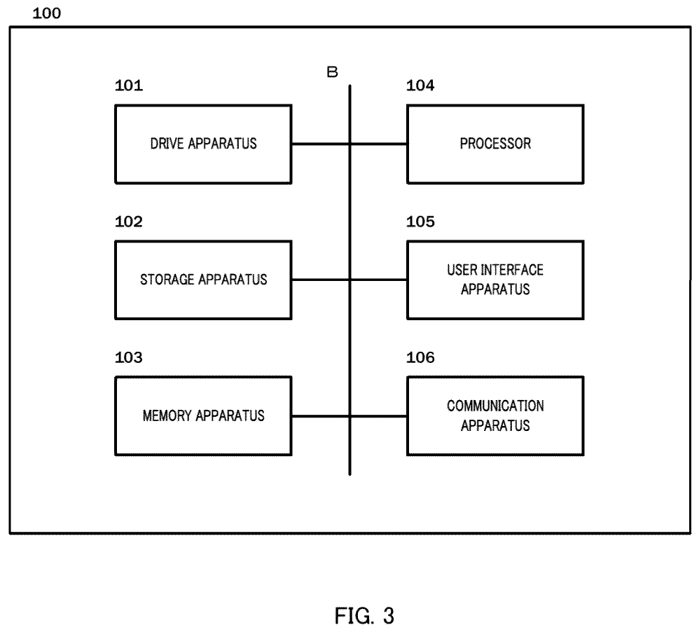

The information analysis apparatus 100 may be realized by a computing apparatus such as a server, a personal computer (PC), a smartphone, or a tablet and may have, for example, a hardware configuration as illustrated in FIG. 3. That is, the information analysis apparatus 100 includes a drive apparatus 101, a storage apparatus 102, a memory apparatus 103, a processor 104, a user interface (UI) apparatus 105, and a communication apparatus 106, which are interconnected via a bus B.

A program or an instruction that implements various functions and processing in the information analysis apparatus 100 may be stored in a detachable storage medium such as a compact disk-read only memory (CD-ROM) or a flash memory. When the above storage medium is set in the drive apparatus 101, the program or the instruction is installed in the storage apparatus 102 or the memory apparatus 103 from the storage medium via the drive apparatus 101. In this respect, however, the program or the instructions do not necessarily need to be installed from the storage medium, but may be downloaded from any external apparatus via a network or the like.

The storage apparatus 102 is realized by a hard disk drive or the like, and stores, together with an installed program or instruction, a file, data, or the like used for the execution of the program or instruction.

The memory apparatus 103 is realized by a random access memory, a static memory, or the like, and when a program or an instruction is activated, reads the program, the instruction, data, or the like from the storage apparatus 102 and stores the read program, instruction, data, or the like. The storage apparatus 102, the memory apparatus 103, and the detachable storage medium may be collectively referred to as a non-transitory storage medium.

The processor 104 may be realized by one or more central processing units (CPUs), graphics processing units (GPUs), processing circuitry, or the like, which can be constituted by one or more processor cores, and executes various functions and processing of the information analysis apparatus 100 according to a program and an instruction stored in the memory apparatus 103, data such as a parameter necessary for executing the program or the instruction, and the like.

The user interface (UI) apparatus 105 may be constituted by an input apparatus such as a keyboard, a mouse, a camera, or a microphone, an output apparatus such as a display, a speaker, a headset, or a printer, and an input/output apparatus such as a touch screen, and realizes an interface between the user and the information analysis apparatus 100. For example, the user operates the information analysis apparatus 100 by operating a graphical user interface (GUI) displayed on a display or a touch screen with a keyboard, a mouse, or the like.

The communication apparatus 106 is realized by various communication circuitry that executes wired and/or wireless communication processing with an external apparatus or a communication network such as the Internet, a local area network (LAN), or a cellular network.

However, the above-described hardware configuration is merely an example, and the information analysis apparatus 100 according to the present disclosure may also be realized by any other appropriate hardware configuration.

### Information Analysis Apparatus

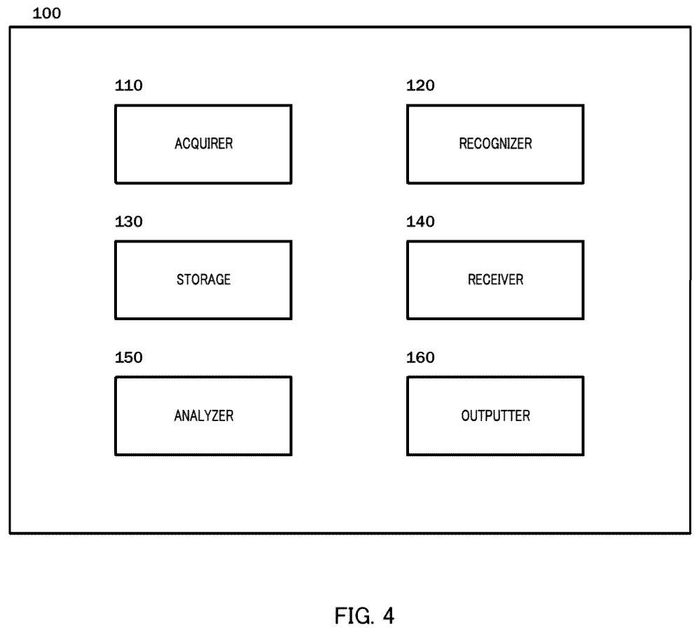

Next, the information analysis apparatus 100 according to an exemplary embodiment of the present disclosure will be described. FIG. 4 is a block diagram illustrating a functional configuration of the information analysis apparatus 100 according to an exemplary embodiment of the present disclosure.

As illustrated in FIG. 4, the information analysis apparatus 100 includes an acquirer 110, a recognizer 120, a storage 130, a receiver 140, an analyzer 150, and an outputter 160. The information analysis apparatus 100 may be realized by a program that causes one or more processors 104 as the acquirer 110, the recognizer 120, the storage 130, the receiver 140, the analyzer 150, and/or the outputter 160 to operate. In addition, all of the acquirer 110, the recognizer 120, the storage 130, the receiver 140, the analyzer 150, and the outputter 160 do not necessarily need to be provided in the information analysis apparatus 100, and one or more of the acquirer 110, the recognizer 120, the storage 130, the receiver 140, the analyzer 150, and/or the outputter 160 may be provided in the information analysis system 10. For example, the acquirer 110 and the recognizer 120 may be included in the imaging apparatus 20, and/or the storage 130 may not be provided in the information analysis apparatus 100.

The acquirer 110 acquires non-language time-series data. For example, the non-language time-series data may be time-series data such as a moving image, an image, and a sound acquired at a plurality of time points or within a certain period. As illustrated in FIGS. 1 and 2, the acquirer 110 acquires moving image data from the imaging apparatus 20 in the present exemplary embodiment.

The recognizer 120 recognizes the situation of a target based on non-language time-series data. As illustrated in FIGS. 1 and 2, the recognizer 120 acquires log information from moving image data by utilizing the behavior recognition model 40 in the present exemplary embodiment. The log information may indicate, in association with time, a recognition result of the behavior of the target person recognized by the behavior recognition model 40 in the moving image data, for example. For example, as illustrated in FIG. 1, the log information may indicate each behavior of the target person and/or each operation of the target thing in time series, such as “dd o'clock ee to ff minutes: walking”, “gg o'clock hh to ii minutes: trotting”, and so forth on “cc(day)/bb(month)/aa(year)”.

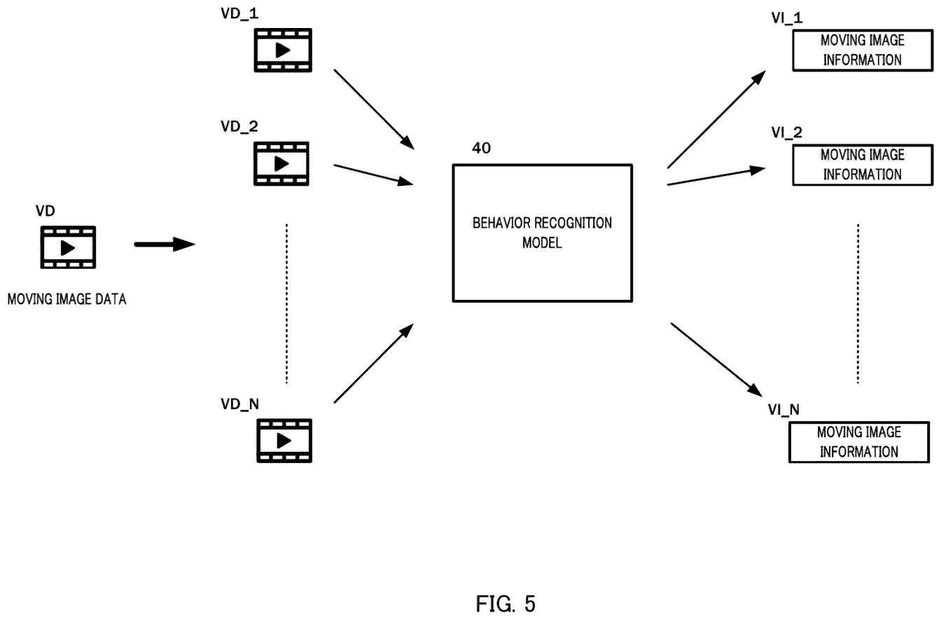

In an exemplary embodiment, the recognizer 120 may divide moving image data into a plurality of moving image data segments. For example, in a case where the behavior recognition model 40 is realized as a machine learning model for moving image analysis, there is a possibility that moving image data for a long time will apply a large processing load to the behavior recognition model 40. For this reason, the recognizer 120 may divide moving image data into moving image data segments of a predetermined time interval appropriate for the amount of calculation of the behavior recognition model 40, for example. For example, in a case where moving image data VD is divided into moving image data segments VD_1, VD_2, . . . , VD_N as illustrated in FIG. 5, the recognizer 120 may input each moving image data segment VD_i into the behavior recognition model 40 and may acquire moving image information VI_i of each moving image data segment VD_i from the behavior recognition model 40. In this case, the moving image information VI_i may indicate the situation of the target in the moving image data segment VD_i (for example, the behavior of the target person, the operation of the target thing, or the like), in association with time information.

Alternatively, in another example, the recognizer 120 may collectively input VD_1 to VD_i into the behavior recognition model 40 and acquire moving image information VI_1 to VI_i corresponding to VD_1 to VD_i from the behavior recognition model 40. That is, the recognizer 120 may be configured to collectively handle a plurality of moving image data segments as one moving image data segment, and to acquire moving image information corresponding to the plurality of moving image data segments. In this case, the moving image information VI_1 to VI_i may indicate the situation of the target in the moving image data segments VD_1 to VD_i (for example, the behavior of the target person, the operation of the target thing, or the like), in association with time information.

In addition, each moving image information VI_i may indicate an attribute(s) (for example, male/female, adult/minor, age group, clothing, and/or the like) of a person, time, a type and/or time of a detected behavior, and the like in the moving image data segment VD_i.

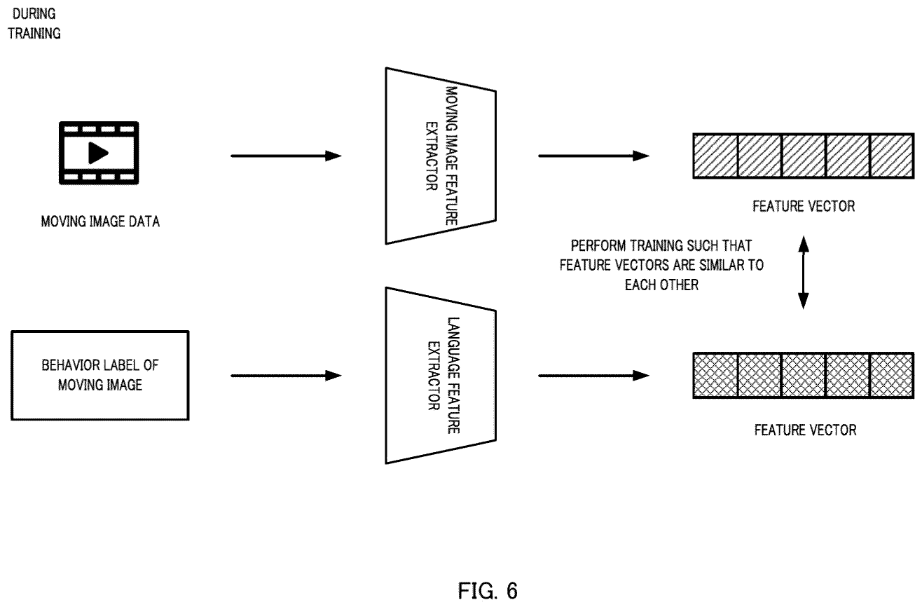

The behavior recognition model 40 utilized by the recognizer 120 may be generated, for example, by training processing as illustrated in FIG. 6 (for more details, see, for example, “Zero-shot abnormal behavior recognition using pretrained DNN” (the 25th Meeting on Image Recognition and Understanding) or the like. Specifically, a moving image feature extractor and a language feature extractor are prepared, moving image data for training is input into the moving image feature extractor, and a behavior label (for example, walking, swimming, or the like) corresponding to the moving image data input into the moving image feature extractor is input into the language feature extractor. Then, the parameters of the moving image feature extractor are adjusted such that the feature vector output from the moving image feature extractor and the feature vector output from the language feature extractor are similar to each other. When a predetermined termination condition is satisfied, for example, when all the training data has been processed, the training processing is terminated, and the moving image feature extractor whose parameters have been updated is made available as the behavior recognition model 40 to the information analysis apparatus 100.

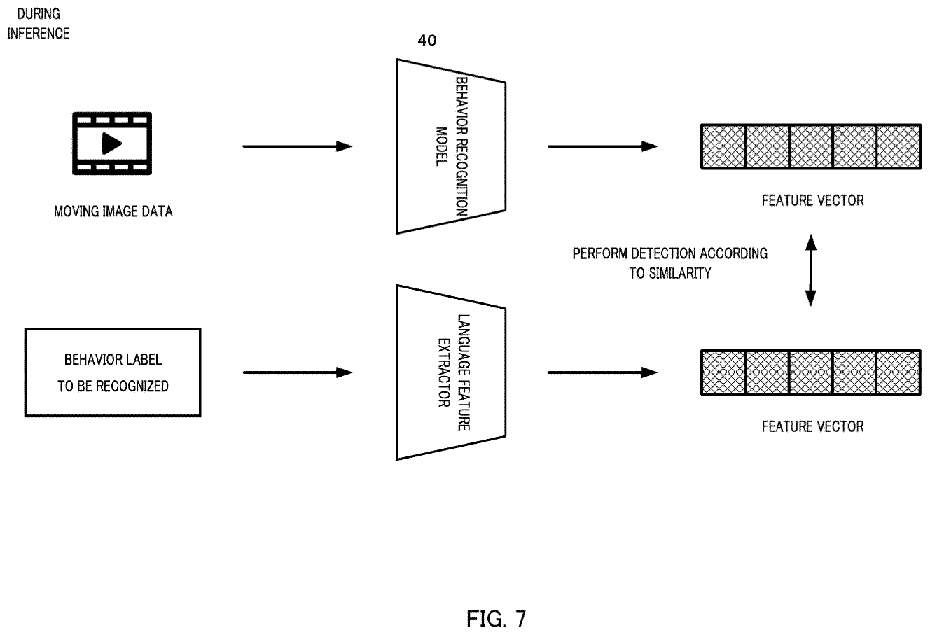

In the inference processing, as illustrated in FIG. 7, the behavior recognition model 40 can recognize an arbitrary behavior according to the similarity between the moving image feature vector obtained from the moving image data and the language feature vector obtained from an arbitrary behavior label (for example, walking, swimming, or the like). The recognizer 120 can recognize the situation of the target from the moving image data by utilizing the behavior recognition model 40 trained as described above. As described above, the behavior recognition model 40 may be a machine learning model trained to recognize an arbitrary behavior from non-language time-series data by utilizing a moving image feature model and a language feature model.

However, the behavior recognition model 40 according to the present disclosure is not necessarily limited thereto, and may be another type of machine learning model. For example, the behavior recognition model 40 may be any 2D model that aggregates and recognizes features for each image by 2D CNN, Transformer, or the like. In addition, the behavior recognition model 40 may be any 3D model that acquires and recognizes a feature of a moving image including time-series data by 3D CNN, cube-based Transformer, or the like. In addition, the behavior recognition model 40 may be a two-stream model that aggregates and recognizes features of an RGB image and an optical flow image (including motion information). In addition, the behavior recognition model 40 may be a Skeleton-based model that estimates key points (human joint points, thing end points, and the like) for each image and aggregates and recognizes the key points. Alternatively, the behavior recognition model 40 may be any combination of the above-described models.

The storage 130 stores the situation of a target as log information of language data. For example, the storage 130 may store the moving image information VI_1 to VI_N acquired from the behavior recognition model 40 as log information. For example, the log information may be a list of the moving image information VD_1 to VD_N in time series, that is, may be data in any format such as a specific file format (for example, json file or the like), a table format, or a text format, in which an attribute(s) (for example, male/female, adult/minor, age group, clothing, and/or the like) of an imaged person, time, a type and/or time of a detected behavior, and the like in the moving image data VD_1 to VD_N are indicated in time series.

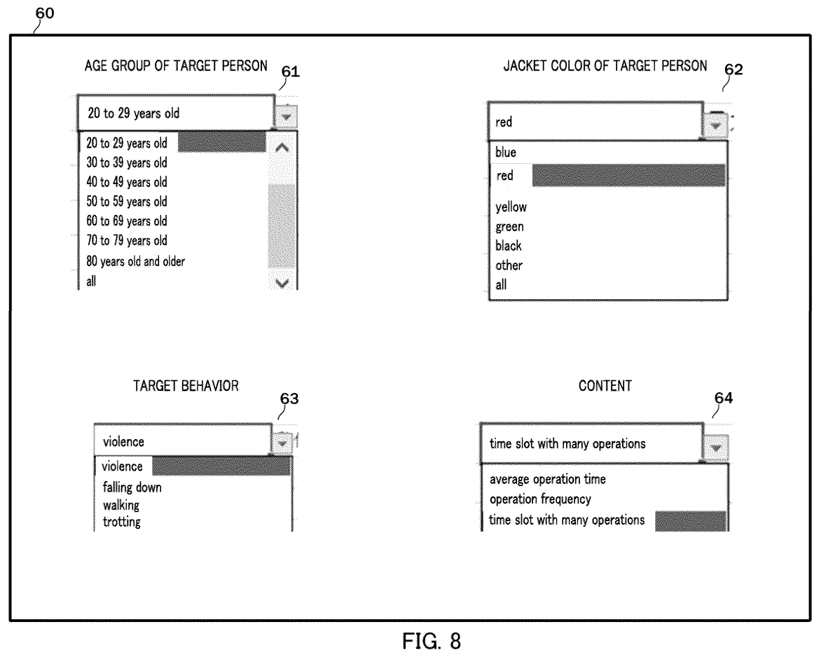

The receiver 140 receives an analysis request. Specifically, the receiver 140 may receive an analysis request including an analysis content for moving image data, from the user terminal 30. For example, in a case where the user is allowed to set the age group of the target person, the jacket color of the target person, the target behavior, and the content as the analysis content, the receiver 140 may transmit a setting screen 60 as illustrated in FIG. 8 to the user terminal 30. The user may select input items of an age group 61 of the target person, a jacket color 62 of the target person, a target behavior 63, and content 64, which are displayed in pull-down menus on the setting screen 60. For example, in the illustrated example, “20 to 29 years old” is selected as the age group 61 of the target person, “red” is selected as the jacket color 62 of the target person, “violence” is selected as the target behavior 63, and “time slot with many operations” is selected as the content 64. Note that, the analysis content is not limited to the above and may be any other content, and is not limited to the pull-down menu format and may involve text input by the user, or the like. For example, the user may input, as described above, an analysis content such as “What is the total time during which the target person has started walking and then has trotted on cc(day)/bb(month)/aa(year)?” with text data into the user terminal 30.

The analyzer 150 executes analysis based on log information and an analysis request. Specifically, the analyzer 150 inputs log information and an analysis content, which is included in an analysis request, into the language model 50 and acquires an analysis result from the language model 50. Here, the language model 50 may be, for example, a general-purpose natural language analysis model of a question-and-answer type such as ChatGPT, or may be any type of natural language analysis model trained utilizing training data.

For example, it is assumed that the imaging apparatus 20 images a certain downtown street and the behavior recognition model 40 recognizes the behaviors of passers-by from moving image data and generates log information. For example, it is assumed that in the log information, an attribute(s) such as an age group and clothing of a passer-by is/are indicated, and the behavior of the passer-by such as “walking”, “stopping”, “trotting”, “talking”, or “violence” or the like is indicated in association with time. In addition, in a case where the receiver 140 receives an analysis content indicating the age group 61 of “20 to 29 years old”, the jacket color 62 of “red”, the behavior 63 of “operation”, and the content 64 of “time slot with many operations” as illustrated in FIG. 8, the analyzer 150 inputs this log information and this analysis content into the language model 50 and acquires an analysis result for the log information from the language model 50. For example, the analyzer 150 may acquire, from the language model 50, an answer such as “The time slot in which there are many people who are 20 to 29 years old, wear a red jacket, and exhibit violent behaviors is from 11 p.m. to 2 a.m.

Alternatively, in a case where the user inputs an analysis content, which reads: “What is the total time during which the target person has started walking and then has trotted on cc(day)/bb(month)/aa(year)?”, into the user terminal 30, the analyzer 150 may input the analysis content and log information into the language model 50 and may acquire, from the language model 50, an analysis result that reads: “The total time during which the target person has started walking and then has trotted is xx minutes.” or the like. As described above, utilizing the language model 50 makes it possible to detect, from log information, a composite operation such as “starting walking and then trotting” obtained by combining behaviors such as “walking” and “trotting” which can be recognized by the behavior recognition model 40. Here, the “composite operation” may indicate a combination of a plurality of operations recognizable by the behavior recognition model 40.

The outputter 160 outputs an analysis result. Specifically, the outputter 160 transmits an answer acquired from the language model 50 by the analyzer 150 to the user terminal 30. Thus, the user terminal 30 can acquire the analysis result for a requested analysis content.

### Information Analysis Processing

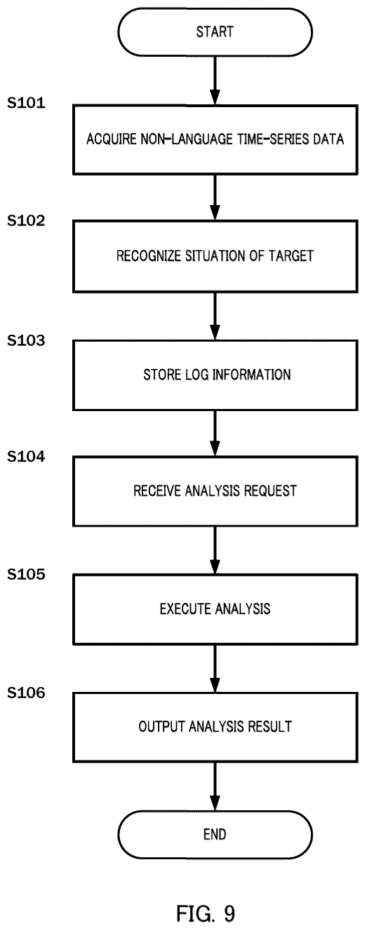

Next, information analysis processing according to an exemplary embodiment of the present disclosure will be described. The information analysis processing is executed by the information analysis apparatus 100, and more specifically, may be realized when one or more processors 104 of the information analysis apparatus 100 execute one or more programs or instructions stored in one or more memory apparatuses 103. FIG. 9 is a flowchart illustrating information analysis processing according to an exemplary embodiment of the present disclosure.

In step S101, the information analysis apparatus 100 acquires non-language time-series data. Here, the non-language time-series data may be audio video data such as a moving image (video), an image, and a sound. For example, the information analysis apparatus 100 may acquire moving image data imaged by a video camera in real time, or may acquire a moving image file imaged in a certain period from a video database or the like.

In step S102, the information analysis apparatus 100 recognizes the situation of the target. Specifically, the information analysis apparatus 100 recognizes the behavior of the target person and/or the operation of the target thing or the like from the non-language time-series data by utilizing the behavior recognition model 40 or the like. For example, the behavior recognition model 40 may generate moving image information indicating an attribute(s) of the target person, the behavior of the target person and/or the like, where the target person has been imaged in the moving image data, in association with time information. In addition, the information analysis apparatus 100 may segment the moving image data into moving image data segments of an appropriate size and may execute behavior recognition processing utilizing the behavior recognition model on each of the moving image data segments. Thus, moving image data for a long time can be processed by a machine learning model.

In step S103, the information analysis apparatus 100 stores log information. The log information may be created based on, for example, moving image information. That is, an attribute(s) of the target person, the behavior of the target person, and/or the like indicated in the moving image information may be stored as the log information in association with time information.

In step S104, the information analysis apparatus 100 receives an analysis request. Specifically, the information analysis apparatus 100 receives an analysis request including an analysis content for the log information from the user terminal 30.

In step S105, the information analysis apparatus 100 executes analysis according to the log information and the analysis content. Specifically, the information analysis apparatus 100 inputs the log information and the analysis content into the language model 50 and acquires an analysis result based on the analysis content for the log information from the language model 50.

In step S106, the information analysis apparatus 100 outputs an analysis result. Specifically, the information analysis apparatus 100 transmits the analysis result acquired from the language model 50 to the user terminal 30. The analysis result that is provided to the user terminal 30 may be acquired from the language model 50, or may be edited so as to improve visibility.

According to the above-described exemplary embodiment, it is possible to acquire, as the log information, a recognition result of the behavior of the target person and/or the operation of the target thing acquired from a behavior recognition model, to set, as the analysis content, a composite operation which is generally difficult to recognize by a behavior recognition model, and to utilize a language model to acquire an analysis result for the acquired log information and the set analysis content. In addition, dividing moving image data into a plurality of moving image data segments and inputting the moving image data segments into the behavior recognition model make it possible to realize information analysis based on an analysis content flexibly specified for moving image data for a long time. In addition, in the exemplary embodiment of the present disclosure, an existing model can be utilized as the behavior recognition model and/or the language model, and the analysis target can be expanded without developing a new model.

Note that, the following supplementary notes are further disclosed with respect to the above description.

### (Supplementary Note 1)

An information analysis system, including:
an acquirer that acquires non-language time-series data;
a recognizer that recognizes a situation of a target based on the non-language time-series data;
a storage that stores the situation of the target as log information of language data;
an receiver that receives an analysis request;
an analyzer that executes analysis based on the log information and the analysis request; and
an outputter that outputs a result of the analysis.

### (Supplementary Note 2)

The information analysis system according to Supplementary Note 1, wherein:
the time-series data is moving image data,
the situation of the target is a behavior of a target person,
the analyzer utilizes a natural language analysis model, and
the natural language analysis model executes analysis based on the log information and the analysis request.

### (Supplementary Note 3)

The information analysis system according to Supplementary Note 2, wherein the recognizer divides the moving image data into a plurality of moving image data segments.

### (Supplementary Note 4)

The information analysis system according to any one of Supplementary Notes 1 to 3, wherein the recognizer utilizes a behavior recognition model that recognizes one or both of an attribute of the target and the behavior of a target from the non-language time-series data.

### (Supplementary Note 5)

The information analysis system according to any one of Supplementary Notes 1 to 4, wherein the behavior recognition model is a machine learning model trained to recognize an arbitrary behavior from the non-language time-series data by utilizing a moving image feature model and a language feature model.

### (Supplementary Note 6)

The information analysis system according to any one of Supplementary Notes 1 to 5, wherein the log information indicates an attribute of the target and a behavior of the target in association with time.

### (Supplementary Note 7)

The information analysis system according to any one of Supplementary Notes 1 to 6, wherein the analysis request includes an analysis content that indicates one or more of an attribute of the target, a behavior of the target, and a content of the target.

### (Supplementary Note 8)

An information analysis method, wherein a computer executes:
acquiring non-language time-series data;
recognizing a situation of a target based on the non-language time-series data;
storing the situation of the target as log information of language data;
receiving an analysis request;
executing analysis based on the log information and the analysis request; and
outputting a result of the analysis.

### (Supplementary Note 9)

A program that causes a computer to execute:
acquiring non-language time-series data;
recognizing a situation of a target based on the non-language time-series data;
storing the situation of the target as log information of language data;
receiving an analysis content;
executing analysis based on the log information and the analysis request; and
outputting a result of the analysis.

Although the exemplary embodiment of the present disclosure has been described in detail above, the present disclosure is not limited to the above-described specific embodiment, and various modifications and changes can be made within the scope of the gist of the present disclosure described in the claims.

### REFERENCE SIGNS LIST

10 Information analysis system
20 Imaging apparatus
30 User terminal
40 Behavior recognition model
50 Language model
100 Information analysis apparatus
110 Acquirer
120 Recognizer
130 Storage
140 Receiver
150 Analyzer
160 Outputter

1. An information analysis system, comprising at least one hardware processor, wherein the at least one hardware processor functions as:
an acquirer that acquires non-language time-series data;
a recognizer that recognizes a situation of a target based on the non-language time-series data;
a storage that stores the situation of the target as log information of language data;
a receiver that receives an analysis request;
an analyzer that executes analysis based on the log information and the analysis request; and
an outputter that outputs a result of the analysis.

2. The information analysis system according to claim 1, wherein:
the time-series data is moving image data,
the situation of the target is a behavior of a target person,
the analyzer utilizes a natural language analysis model, and
the natural language analysis model executes analysis based on the log information and an analysis content of the analysis request.

3. The information analysis system according to claim 2, wherein the recognizer divides the moving image data into a plurality of moving image data segments.

4. The information analysis system according to claim 1, wherein the recognizer utilizes a behavior recognition model that recognizes one or both of an attribute of the target and a behavior of the target from the non-language time-series data.

5. The information analysis system according to claim 4, wherein the behavior recognition model is a machine learning model trained to recognize an arbitrary behavior from the non-language time-series data by utilizing a moving image feature model and a language feature model.

6. The information analysis system according to claim 1, wherein the log information indicates an attribute of the target and a behavior of the target in association with time.

7. The information analysis system according to claim 1, wherein the analysis request includes an analysis content that indicates one or more of an attribute of the target, a behavior of the target, and a content of the target.

8. An information analysis method, wherein a computer executes:
acquiring non-language time-series data;
recognizing a situation of a target based on the non-language time-series data;
storing the situation of the target as log information of language data;
receiving an analysis request;
executing analysis based on the log information and the analysis request; and
outputting a result of the analysis.

9. A non-transitory computer-readable recording medium storing a program that causes a computer to execute:
acquiring non-language time-series data;
recognizing a situation of a target based on the non-language time-series data;
storing the situation of the target as log information of language data;
receiving an analysis content;
executing analysis based on the log information and the analysis request; and
outputting a result of the analysis.
